(19) United States
(12) Patent Application Publication
(10) Pub. No.: US 2015/0138309 A1
(43) Pub. Date: May 21, 2015

(54) PHOTOGRAPHING DEVICE AND STITCHING METHOD OF CAPTURED IMAGE

(71) Applicant: Electronics and Telecommunications Research Institute, Daejeon (KR)

(72) Inventors: Joo Myoung SEOK, Daejeon (KR); Seong Yong LIM, Daejeon (KR); Yong Ju CHO, Daejeon (KR); Ji Hun CHA, Daejeon (KR)

(73) Assignee: Electronics and Telecommunications Research Institute, Daejeon (KR)

(21) Appl. No.: 14/168,435

(22) Filed: Jan. 30, 2014

(30) Foreign Application Priority Data
Nov. 21, 2013 (KR) 10-2013-0142163

(51) Int. Cl. H04N 5/232; G06T 11/60; G06K 9/46

(52) U.S. Cl. CPC H04N 5/23238; G06K 9/4604; G06T 11/60
USPC 348/36

(57) ABSTRACT

A stitching method of a captured image is disclosed. The stitching method includes capturing a plurality of images having different viewing angles, setting a feature point extraction region on the plural images, extracting a plurality of feature points from a plurality of objects in the set region, extracting a combination line connecting corresponding feature points based on the plural extracted feature points, outputting the extracted combination line, and combining the plural images based on the extracted combination line. Accordingly, the stitching method provides an effective and high-quality stitched image.

This application claims priority to and the benefit of Korean Patent Application No. 10-2013-0142163, filed on Nov. 21, 2013, which is hereby incorporated by reference as if fully set forth herein.

### BACKGROUND OF THE INVENTION

1. Field of the Invention

The present invention relates to a photographing device and a stitching method of a captured image, and more particularly, to a photographing device and a stitching method of a captured image, for capturing a plurality of images via a multi camera and combining adjacent images, and a stitching method of a captured image.

2. Discussion of the Related Art

In general, in order to generate a high quality panoramic image, a multi camera needs to capture images that partially overlap each other. The multi camera calculates homography information as a geometric correlation between adjacent images by extracting feature points from a redundantly photographed object and matching corresponding feature points to each other.

Stitching for combining adjacent images is performed using the calculated homography information. However, in a procedure for calculating the homography information, the extraction and matching of the feature points are performed on all images. Thus, the extracting and matching of the feature points are time consuming and also affect performance of a photographing device. Image characteristics also affect stitched image quality. For example, when the number of feature points is extremely insufficient due to the characteristics of an image such as a night view, a sky view, a downtown area view, etc., the amount of basic information for matching and calculation of homography information is sufficient, and thus, correlation calculation and matching may fail, thereby obtain wrong homography. In addition, when a near object and a distant object are simultaneously photographed, a stitched image may be distorted due to a view difference between a case in which homography is calculated based on feature points of the near object and a case in which homography is calculated based on feature points of the distant object.

Accordingly, there is a need for a technology for preventing stitching failure and errors.

### SUMMARY OF THE INVENTION

Accordingly, the present invention is directed to a photographing device and a stitching method of a captured image that substantially obviate one or more problems due to limitations and disadvantages of the related art.

An object of the present invention is to provide a stitching method of a captured image that may optimally manage an algorithm operation by collecting input information to reduce a failure rate, thereby achieving an improved panoramic image.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a stitching method of a captured image of a multi camera includes capturing a plurality of images having different viewing angles, setting a feature point extraction region on the plural images, extracting a plurality of feature points from a plurality of objects in the set region, extracting a combination line connecting corresponding feature points based on the plural extracted feature points, outputting the extracted combination line, and combining the plural images based on the extracted combination line, wherein the setting of the feature point extraction region includes setting the feature point extraction region based on a selected point when a selection command for one point is input on at least one of the plural images.

The setting of the feature point extraction region may include setting a rectangular region having a line connecting a first point and a second point as one side as the feature point extraction region when a drag command from the first point to the second point is input on the at least one of the plural images.

The setting of the feature point extraction region may include setting the feature point extraction region with respect to a preset region based on the selected point.

The setting of the feature point extraction region may include setting a region between a straight line formed by vertically extending the first point and a straight line formed by vertically extending the second point as the feature point extraction region.

The setting of the feature point extraction region may include removing a selected region and setting the feature point extraction region when a selection command for a predetermined region is input on at least one of the plural images.

The setting of the feature point extraction region may include setting the feature point extraction region based on a selected command when a selection command for at least one object in at least one of the plural images is input.

The method may further include receiving selection of a feature point from which the combination line is to be extracted, among the plural feature points.

The method may further include receiving a combination line to be removed among the extracted combination lines, wherein the combining of the plural images may include combining the plural images based on a combination line except for the removed combination line among the extracted combination lines.

The outputting of the combination line may include the combination line with different colors according to an image combination region.

In another aspect of the present invention, a photographing device includes a photographing unit for a plurality of images having different viewing angles, a controller for setting a feature point extraction region on the plural images, extracting a plurality of feature points from a plurality of objects in the set region, and extracting a combination line connecting corresponding feature points based on the plural extracted feature points, and an output unit for outputting the extracted combination line, wherein the controller sets the feature point extraction region based on a selected point when a selection command for one point is input on at least one of the plural images, and combines the plural images based on the extracted combination line.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for explanation of a procedure of photographing an object using a photographing device according to an embodiment of the present invention;

FIG. 2 is a block diagram of a photographing device according to an embodiment of the present invention;

FIGS. 3 to 7 illustrate a method of setting a feature point extraction region according to various embodiments of the present invention;

FIG. 8 is a diagram for explaining a method of selecting a feature point according to an embodiment of the present invention;

FIG. 9 is a diagram for explaining a method of removing a combination line according to an embodiment of the present invention;

FIG. 10 is a flowchart of a stitching method of a captured image according to an embodiment of the present invention; and

FIG. 11 is a flowchart of a stitching method of a captured image according to another embodiment of the present invention.

### DETAILED DESCRIPTION OF THE INVENTION

Reference will now be made in detail to the preferred embodiments of the present invention, examples of which are illustrated in the accompanying drawings. The features of the present invention will be more clearly understood from the accompanying drawings and should not be limited by the accompanying drawings.

Most of the terms used herein are general terms that have been widely used in the technical art to which the present invention pertains. However, some of the terms used herein may be created reflecting intentions of technicians in this art, precedents, or new technologies. Also, some of the terms used herein may be arbitrarily chosen by the present applicant. In this case, these terms are defined in detail below. Accordingly, the specific terms used herein should be understood based on the unique meanings thereof and the whole context of the present invention.

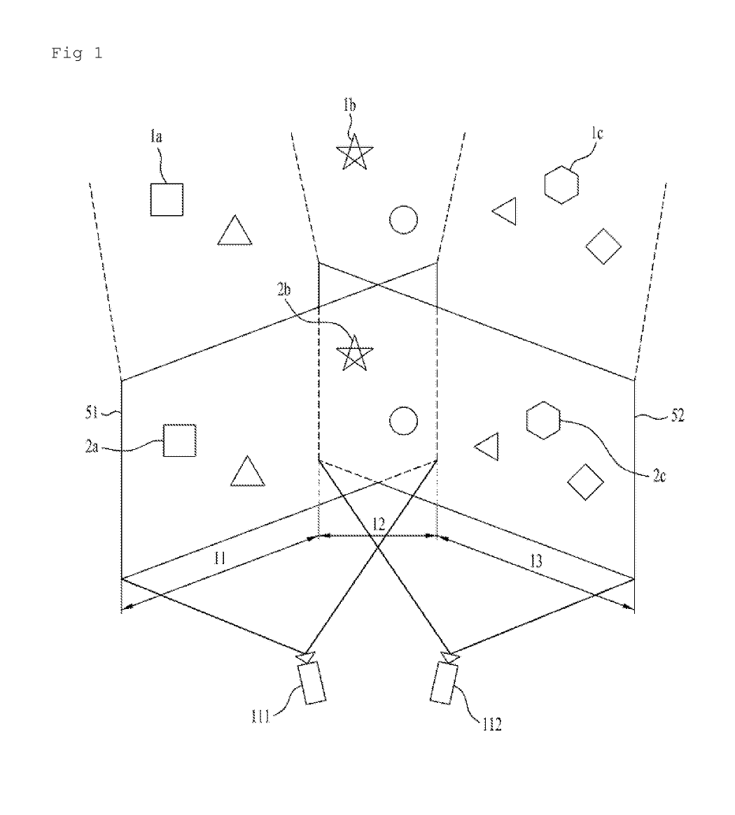

FIG. 1 is a diagram for explanation of a procedure of photographing an object using a photographing device according to an embodiment of the present invention.

FIG. 1 illustrates a multi camera 111 and 112, a plurality of objects 1a, 1b, and 1c, and images 51 and 52 captured by the multi camera 111 and 112. The multi camera 111 and 112 may include a first camera 111 and a second camera 112. The first and second cameras 111 and 112 are arranged in a radial direction and redundantly photograph predetermined regions of the objects 1a, 1b, and 1c. For panoramic photography, the first and second panoramas 111 and 112 are arranged with respect to one photograph central point and have the same viewing angle and focal distance. In addition, the first and second cameras 111 and 112 may have the same resolution.

As illustrated in FIG. 1, the plural objects 1a, 1b, and 1c present in an effective viewing angle of photography are projected to sensors of the first and second cameras 111 and 112. In this case, the first and second cameras 111 and 112 redundantly perform photography at a predetermined viewing angle, and thus, some objects, i.e., an object 2b is commonly captured by each camera. In this case, in order to stitch input images, adjacent cameras need to redundantly photography by as much as an appropriate viewing angle. The appropriate viewing angle refers to a viewing angle for calculating a feature point and combination line of one object. The feature point refers to a specific point for identifying corresponding points on one object in order to combine adjacent images. The combination line refers to a line for connection between corresponding feature points of one object contained in two images.

That is, the first camera 111 acquires a first image 51 captured by photographing the objects 1a and 1b within a viewing angle of the first camera 111. Similarly, the second camera 112 acquires a second image 52 captured by photographing the objects 1b and 1c within a viewing angle of the second camera 112. The first image 51 includes an object 2a captured with respect to only the first image, and an object 2b that is redundantly captured both in the first and second images 51 and 52. The second image 52 includes an object 2c captured with respect to only the second image 52, and the object 2b that is redundantly captured both in the first and second images 51 and 52. That is, the first image 51 includes a region captured with respect to only the first image 51 and a redundant region 12, and the second image 52 includes a region 13 captured with respect to only the second image 52 and the redundant region 12.

A photographing device (not shown) extracts a feature point from the object 2b contained in the redundant region 12. An extraction region in which the feature point is extracted may be set by a user, and the photographing device may extract the feature point in the set extraction region. Since the photographing device extracts the feature point in a limited region, the photographing device can use a low amount of resources and can perform rapid processing. The photographing device extracts combination lines connecting corresponding feature points from feature points extracted from two images. Among the extracted combination lines, a mismatched combination line or an unnecessary line may be present. Thus, the photographing device may display the combination lines and receive commands for removing or selecting a combination line, thereby increasing a speed for generating a stitched image and improving quality.

Hereinafter, a photographing device will be described in detail.

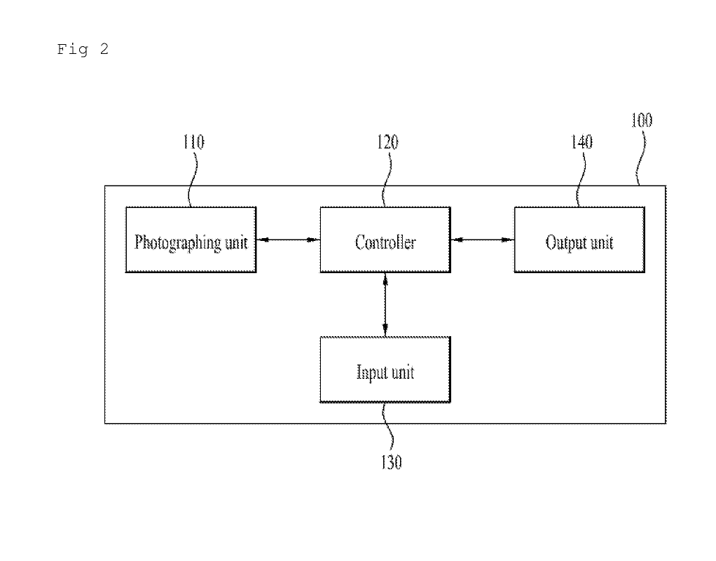

FIG. 2 is a block diagram of a photographing device 100 according to an embodiment of the present invention.

Referring to FIG. 2, the photographing device 100 includes a photographing unit 110, a controller 120, an input unit 130, and an output unit 140. For example, the photographing device 100 may be an electronic device including a camera and may be embodied as a camera, a camcorder, a smart phone, a tablet personal computer (PC), a notebook PC, a television (TV), a portable multimedia player (PMP), a navigation player, etc.

The photographing unit 110 captures a plurality of images at different viewing angles. The photographing unit 110 may include a plurality of cameras. For example, when the photographing unit 110 includes two cameras, the two cameras may be arranged to have a viewing angle for redundantly photographing a predetermined region. When the photographing unit 110 includes three cameras, the three cameras may be arranged to have a viewing angle for redundantly photographing a predetermined region with adjacent cameras. In some cases, a plurality of cameras may be rotatably arranged within a predetermined range so as to change a size of a redundant region of a viewing angle. The photographing unit 110 may include only one camera. In this case, the captured image may be captured so as to partially overlap each other.

The controller 120 sets a region in which a feature point is to be extracted, in a plurality of images captured by each camera. The region may be set using a preset method or using various methods according to a user command. A detailed method of extracting a feature point will be described later. In some cases, the controller 120 may receive a command for selecting a specific region, remove a selected region, and then, extract the feature point from the remaining region.

The controller 120 extracts a plurality of feature points from an object within a feature point extraction region. The controller 120 may control the output unit 140 to display the extracted feature point. According to an embodiment of the present invention, the controller 120 may receive feature points to be removed among the extracted feature points. The controller 120 may extract combination lines connecting corresponding feature points based on a plurality of feature points from which the input feature points are removed. The controller 120 calculates homography information based on the extracted combination lines. The controller 120 combines a plurality of images based on the extracted combination lines. That is, the controller 120 combines the plural images into one image based on the calculated homography information.

The input unit 130 may receive a command for selecting the feature point extraction region, a command for removing a feature point from extracted feature points, or a command for removing a combination line, from the user. For example, the input unit 130 may include a touch sensor to receive a touch input and may be configured to receive a signal from an external input device such as a mouse or a remote controller.

The output unit 140 outputs a captured image and outputs extracted combination lines. In addition, the output unit 140 may display information about the feature point extraction region, a plurality of extracted feature points, selected feature points, or removed combination lines.

Likewise, the photographing device 100 may extract a feature point from an object within a redundant region and combines images to generate a panoramic image. Hereinafter, a method of setting a feature point extraction region will be described with regard to various embodiments of the present invention.

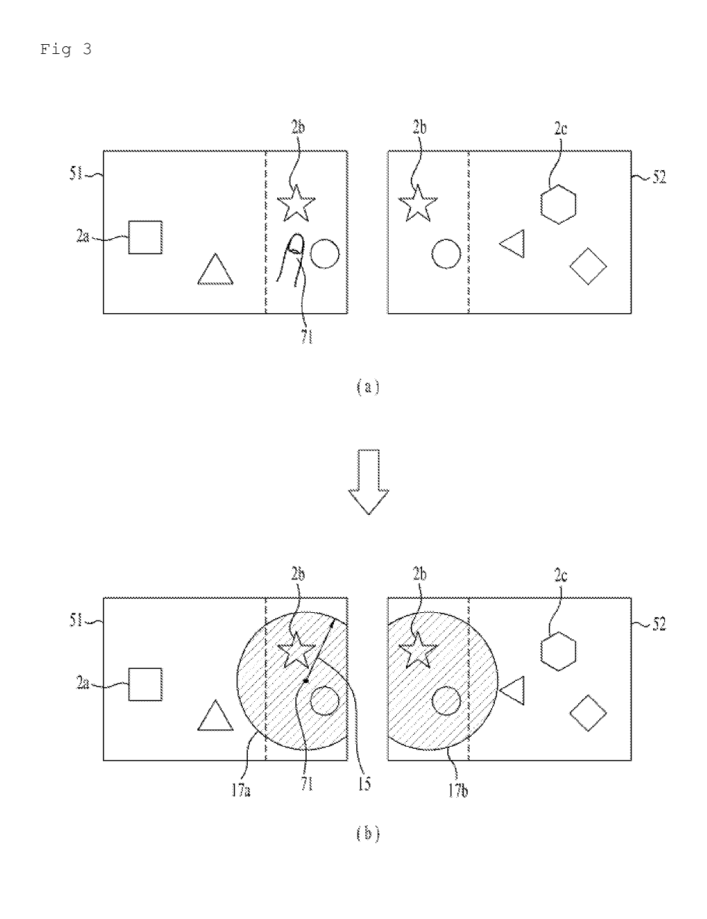

FIG. 3 illustrates a method of setting a predetermined region to a feature point extraction region, according to a first embodiment of the present invention.

A photographing device may receive a command for selecting one point in any one of a plurality of images. Upon receiving the selection command, the photographing device may set the feature point extraction region based on the selected point.

FIG. 3(A) illustrates the first image 51 captured by a first camera of a multi camera and the second image 52 captured by a second camera of the multi camera. The first image 51 includes the object 2a contained in only the first image 51 and the object 2b that is redundantly contained in the first and second images 51 and 52. The second image 52 includes the object 2c contained in only the second image 52 and the object 2b that is redundantly contained in the first and second images 51 and 52. The photographing device receives a command for selecting a specific point 71 from the user.

FIG. 3(B) illustrates an image in which the feature point extraction region is set. The photographing device may set a region having as a preset distance from the user selected point 71 as a diameter 15. That is, the photographing device may set a preset region as a feature point extraction region 17a based on a point selected according to the user selection command. For example, the preset distance may be set to 5 cm or 10 cm in the captured image. The preset distance may be set in various ways in consideration of a display size, resolution, and a redundant region size of the photographing device.

Even if a region setting command is input on the first image 51, the photographing device may set an extraction region 17b having the same size as the feature point extraction region 17a with respect to a corresponding region of the second image 52. In addition, even if the region setting command is input onto the second image 52, the photographing device may set an extraction region having the same size as the feature point extraction region 17a with respect to a corresponding region of the first image 51. As necessary, the photographing may receive region setting commands on the first image 51 and the second image 52 and the extraction regions, respectively. In this case, the photographing device may connect corresponding feature points set on the first image 51 and the second image 52 to extract combination lines. The photographing device may receive the region setting command on any one of the first image 51 and the second image 52 to extract the extraction region or receive a region setting command of each of the first image 51 and the second image 52 to set the extraction region. The extraction region setting method may be similarly applied to other embodiments of the present invention.

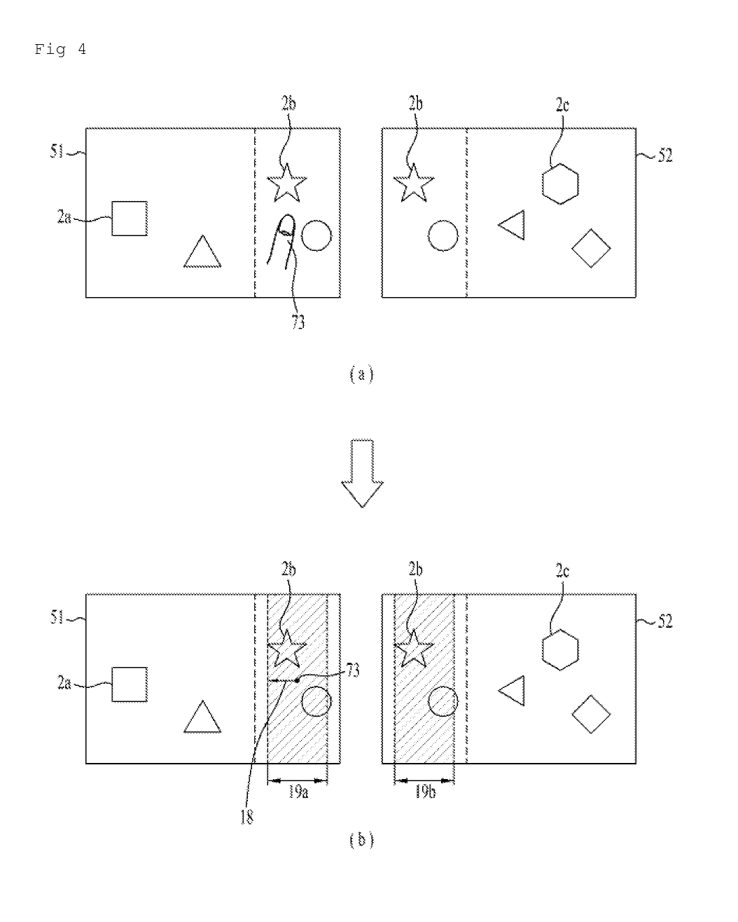

FIG. 4 illustrates a method of setting a predetermined region to a feature point extraction region, according to a second embodiment of the present invention.

FIG. 4(A) illustrates the first image 51 and the second image 52. The first image 51 includes the object 2a contained in only the first image 51 and the object 2b that is redundantly contained in the first and second images 51 and 52. The second image 52 includes the object 2c contained in only the second image 52 and the object 2b that is redundantly contained in the first and second images 51 and 52. The photographing device receives a command for selecting a specific point 73 from the user.

FIG. 4(B) illustrates an image in which the feature point extraction region is set. That is, the photographing device may set a region having a preset distance 18 horizontally spaced from a user selected point 73 as a feature point extraction region 19a. For example, the preset distance 18 may be set to 5 cm or 10 cm. The photographing device may receive the selection command on the first image 51, set a predetermined region as the feature point extraction region 19a, and may set a corresponding region in the second image 52 as a feature point extraction region 19b.

The photographing device may extract feature points from objects in the feature point extraction regions 19a and 19b set on the first image 51 and the second image 52, respectively.

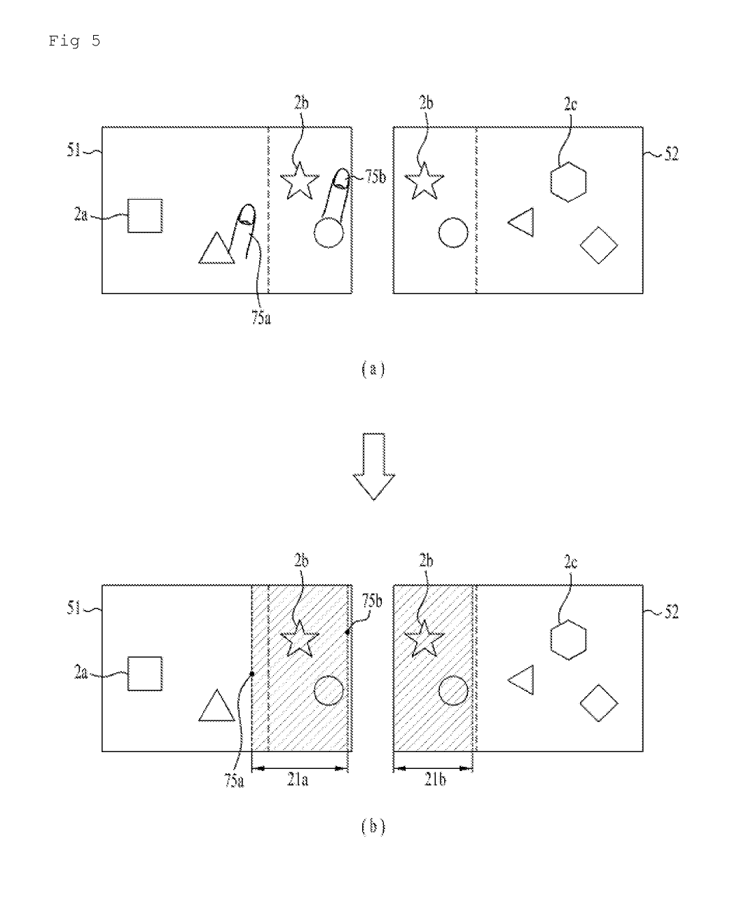

FIG. 5 illustrates a method of setting a predetermined region to a feature point extraction region, according to a third embodiment of the present invention.

FIG. 5(A) illustrates the first image 51 and the second image 52. The first and second images 51 and 52 are the same as in the aforementioned detailed description. The photographing device receives a selection command for a first point 75a and a selection command for a second point 75b from a user.

FIG. 5(B) illustrates an image in which the feature point extraction region is set. That is, the photographing device may set a region between a straight line formed by vertically extending the first point 75a and a straight line formed by vertically extending the second point 75b as a feature point extraction region 21a. The photographing device may set a corresponding region in the second image 52 to the feature point extraction region 21a set in the first image 51 as a feature point extraction region 21b. The feature point extraction regions 21a and 21b contained in the first and second images 51 and 52 include the same object 2b. Thus, the photographing device may extract feature points from the object 2b and extract a combination line connecting corresponding feature points.

The feature point extraction region may be set by selecting a specific region or removing a specific region.

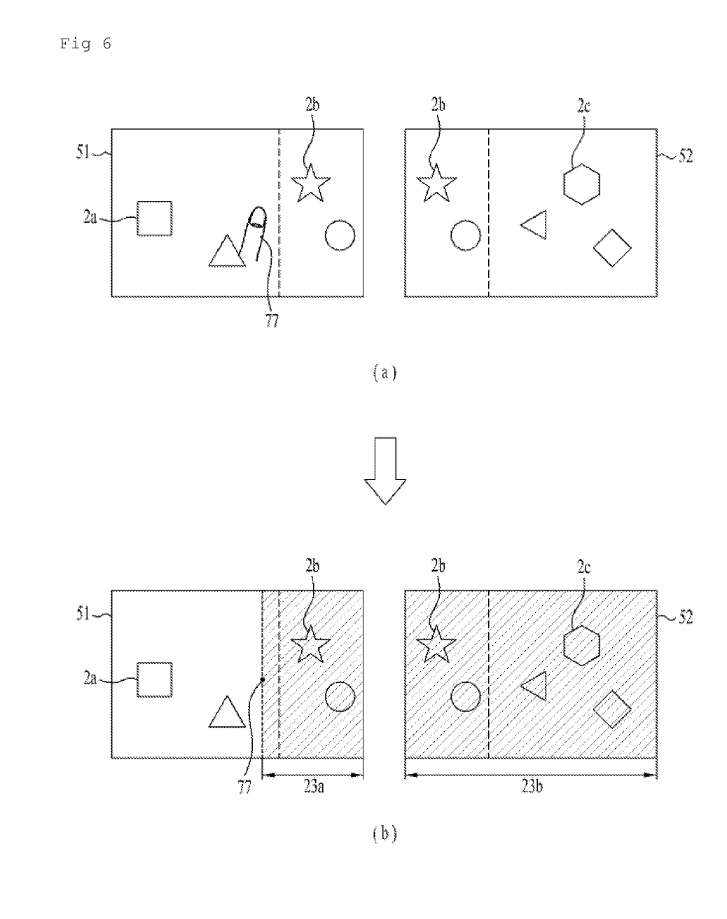

FIG. 6 illustrates a method of setting a predetermined region to a feature point extraction region, according to a fourth embodiment of the present invention.

FIG. 6(A) illustrates the first image 51 and the second image 52. The photographing device receives a selection command for a feature point 77 from the user.

FIG. 6(B) illustrates an image in which the feature point extraction region is set. The photographing device excludes a region that does not include a redundant region from the first image 51 based on an imaginary line formed by vertically extending a selected point 77. The feature point extraction region needs to contain at least a portion of the redundant region. In addition, the photographing device may recognize the redundant region. Thus, the photographing device excludes a left region of the selected point 77 and sets a right region as a feature point extraction region 23a.

The selection command is only for excluding a specific region and is input only for the first image 51. Thus, the photographing device sets the feature point extraction region 23a for only the first image 51. Thus, a feature point extraction region 23b of the second image 52 may be an entire region of the second image 52. That is, the photographing device may remove a selected region to set the feature point extraction region 23a upon receiving a selection command for a predetermined region on any one of a plurality of images.

As necessary, the photographing device may additionally receive a selection command for a specific point with respect to the second image 52 and may also set a feature point extraction region with respect to the second image 52 using the same method as the aforementioned method. In this case, the photographing device may extract feature points from the feature point extraction regions set in the first and second images 51 and 52.

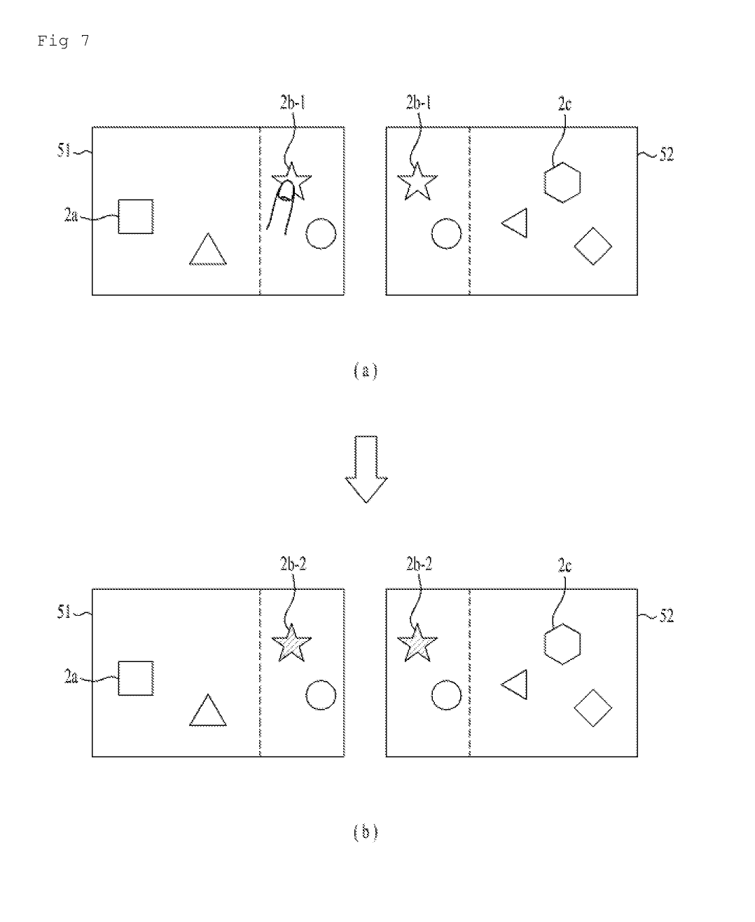

FIG. 7 illustrates a method of setting a predetermined region to a feature point extraction region, according to a fifth embodiment of the present invention.

FIG. 7(A) illustrates the first image 51 and the second image 52. The photographing device receives a selection command for a specific object 2b-1 from a user.

FIG. 7(B) illustrates an image in which the feature point extraction region is set. The photographing device may set a specific object 2b-2 in a redundant region as the feature point extraction region. That is, the photographing device may set the feature point extraction region based on a selected object upon receiving a selection command for at least one object in any one of a plurality of images.

Although FIG. 7(B) illustrates a case in which the set feature point extraction region has the same shape as the selected object 2b-2, the photographing device may set a feature point extraction region having a circular shape or a polygonal shape. In addition, the photographing device may receive a selection command for the feature point extraction region a plurality of number of times. In this case, the photographing device may set plural selected regions as feature point extraction regions, respectively.

According to additional embodiment of the present invention, the photographing device may receive a drag command from a first point to a second point on a captured image. In this case, the photographing device may set a rectangular region including the first point and the second point, as the feature point extraction region. When two images are to be combined, the photographing device may set a corresponding region of an image to a set region in another image, as the feature point extraction region. Alternatively, the photographing device may receive feature point extraction region setting commands with respect to two images, respectively.

According to the aforementioned various embodiments, the photographing device set the feature point extraction region and extracts feature points from an object in the set region. However, many feature points may be unnecessarily extracted or feature points may be extracted with respect to inappropriate points according to algorithm characteristics. Thus, the photographing device may select some of the extracted feature points.

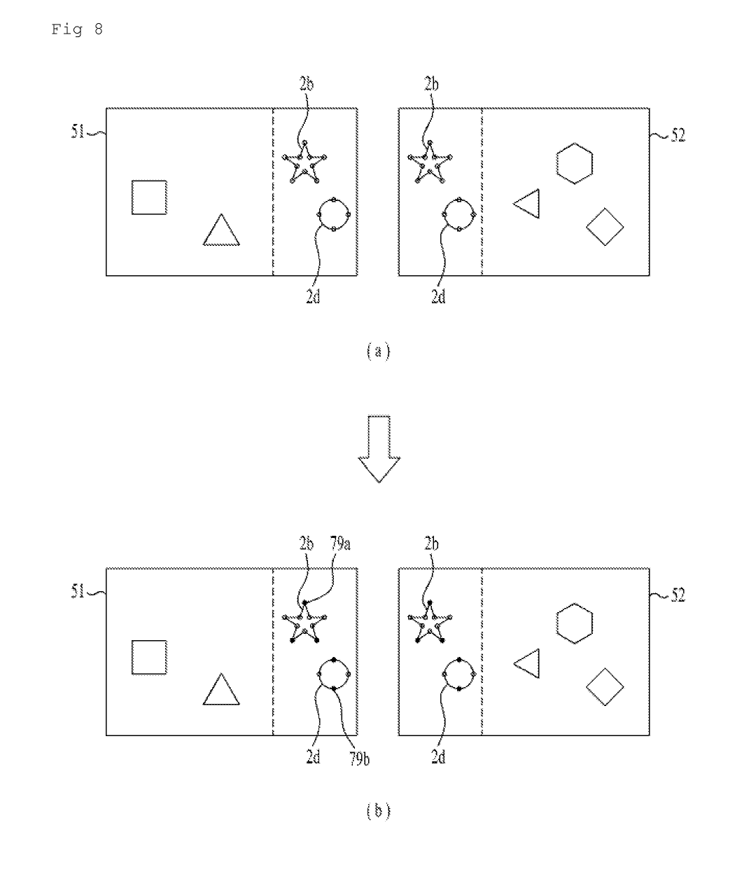

FIG. 8 is a diagram for explaining a method of selecting a feature point according to an embodiment of the present invention.

FIG. 8(A) illustrates the first image 51 and the second image 52. In FIG. 8(A), it is assumed that a redundant region is set as a feature point extraction region. The feature point extraction region includes two objects 2b and 2d. The photographing device may extract a plurality of feature points from the two objects 2b and 2d. The photographing device may select only necessary some feature points from the plural extracted feature points. Alternatively, the photographing device may receive a user input and select feature points.

FIG. 8(B) illustrates an image in which some feature points are selected. The user may input a selection command for some feature points 79a and 79b among the plural extracted feature points. The photographing device may select the some feature points 79a and 79b according to the selection command and may differently display the selected feature points 79a and 79b from the other feature points. The photographing device may extract a combination line based on the selected feature points 79a and 79b to calculate homography information. That is, the photographing device may select at least one feature points for extraction of the combination line among a plurality of feature points. Upon receiving a selection command for a feature point on the first image 51, the photographing device may automatically select a corresponding feature point in the second image 52.

As necessary, the photographing device may receive a command for removing a feature point. In this case, the photographing device may remove an input feature point from an image. When feature points are selected, the photographing device may extract a combination line based on the selected feature points. The photographing device may remove some of the extracted combination lines.

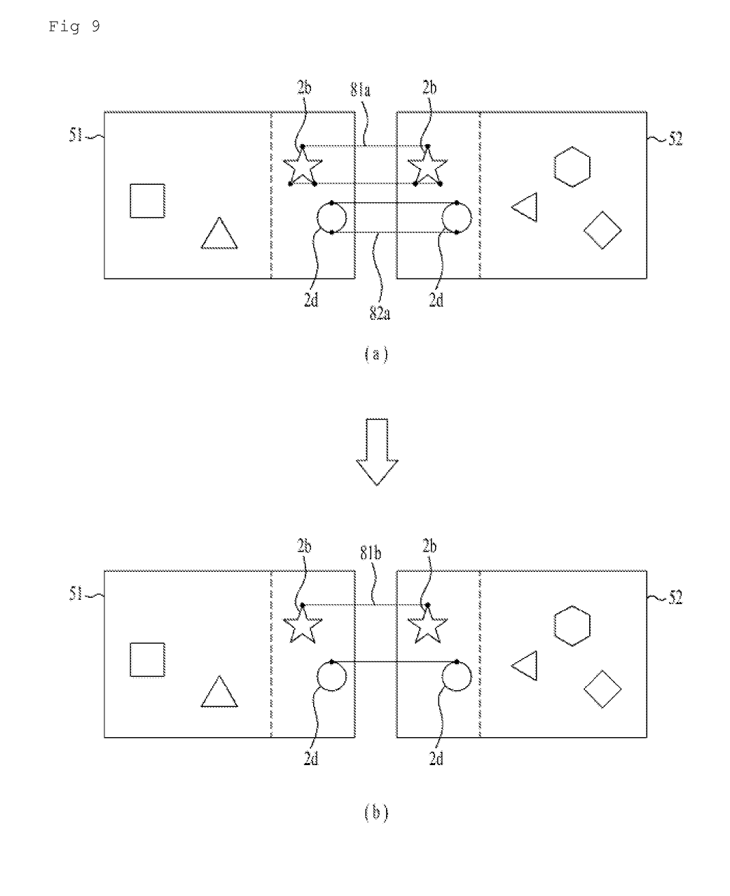

FIG. 9 is a diagram for explaining a method of removing a combination line according to an embodiment of the present invention.

Referring to FIG. 9(A), each of the first and second images 51 and 52 includes two objects 2b and 2d. Each of the two objects 2b and 2d includes a plurality of feature points. The photographing device extracts combination lines connecting feature points in the first image 51 to corresponding feature points in the second image 52. The photographing device may extract corresponding combination lines with respect to all selected or extracted feature points. The photographing device may output the extracted combination lines on an output unit. For example, it is assumed that a first combination line 81a is necessary and a second combination 82a is unnecessary. The photographing device receives information about a combination line to be removed among the extracted combination lines, from the user.

FIG. 9(B) illustrates a case in which some combination lines are removed. That is, upon receiving a command for removing unnecessary combination lines including the second combination line 82a, the photographing device removes combination lines selected according to the removing selection. The photographing device may display a result obtained by removing the combination lines on an output unit. Thus, the photographing device may display only necessary combination lines including the first combination line 81b. The photographing device may calculate homography information using remaining combination lines from which some combination lines are removed. The photographing device may combine adjacent images using the calculated homography information.

Thus far, a procedure for combining two images by a photographing device has been described. However, the photographing device may capture a plurality of images and combine the plural images. The photographing device may output all captured images and output feature points and combination lines with respect to each combination region. The photographing device may output feature points and combination with different colors according to an image combination region in order to differentiate image combination regions.

For example, when the photographing device captures four images, portions of which overlap each other, three combination regions are present. The four images are represented by a first image, a second image, a third image, and a fourth image. In addition, the combination regions may be represented by a first combination region formed by combination between the first image and the second image, a second combination region formed by combination between the second image and the third image, and a third combination region formed by combination between the third image and the fourth image.

In this case, feature points or combination lines associated with the first combination region may be indicated with red color, feature points or combination lines associated with the second combination region may be indicated with yellow color, and feature points or combination lines associated with the third combination region may be indicated with blue color.

The aforementioned number of images, number of combination regions, and colors are purely exemplary, and thus, various numbers of images and combination regions may be present. In addition, feature points and combination lines may be indicated in various colors.

In addition, the photographing device may display a menu such as color information per combination region, a selection button for feature points or combination lines, and a removal button, at one side of an image.

The photographing device may limit a region and an object during extraction of feature points and combination lines and combine adjacent images, thereby increasing computational speed and improving image quality of a stitched image. Hereinafter, a stitching method of a captured image will be described.

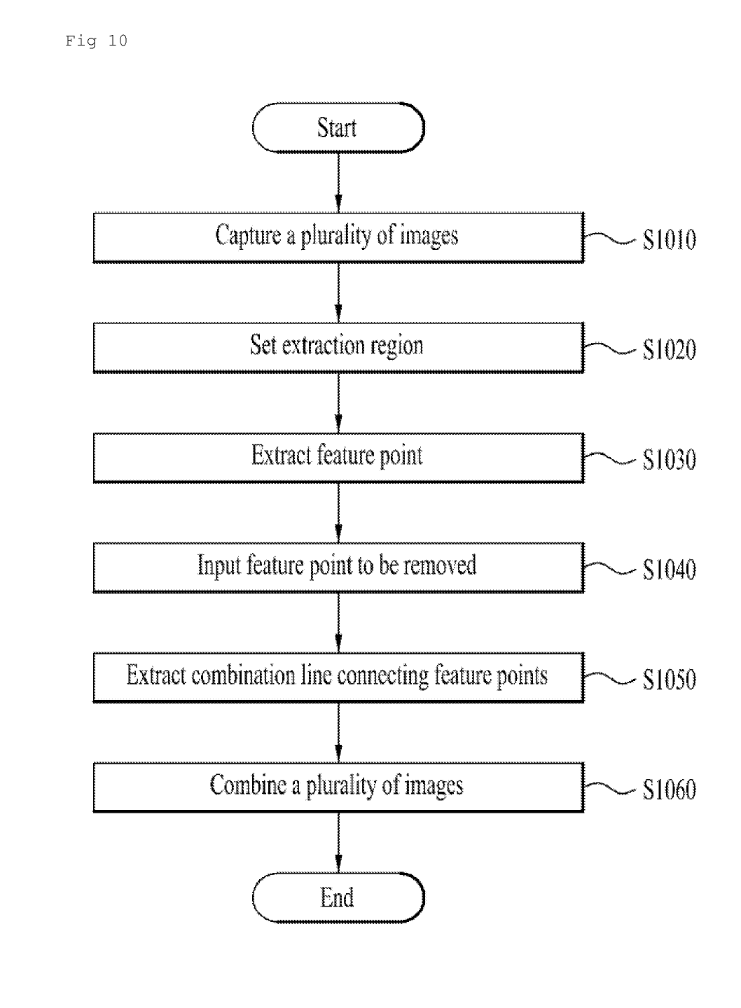

FIG. 10 is a flowchart of a stitching method of a captured image according to an embodiment of the present invention.

A photographing device captures a plurality of images (S1010). The photographing device may include a multi camera having predetermined viewing angles. Thus, the photographing device may capture a plurality of images having different viewing angles.

The photographing device sets a feature point extraction region (S1020). The photographing device sets the feature point extraction region on a plurality of images captured by a plurality of cameras. According to an embodiment of the present invention, when a selection command for one point of any one of a plurality of images is input, the feature point extraction region may be set based on the selected point. According to another embodiment of the present invention, when a selection command for a predetermined region of any one of a plurality of images is input, the feature point extraction region may be set by removing the selected region.

The photographing device extracts a feature point (S1030). The photographing device extracts a plurality of feature points from a plurality of objects in a set region. The photographing device may receive a feature point to be removed (S1040). The photographing device may receive at least one feature point to be removed among a plurality of extracted feature points.

The photographing device extracts a combination line connecting feature points (S1050). The photographing device extracts at least one combination line connecting corresponding feature points based on the plural feature point from which the input feature points are removed.

The photographing device outputs the combination line. The photographing device may receive the combination line to be removed among the extracted combination lines. In this case, the photographing device may combine a plurality of images based on combination lines except for the removed combination lines among the extracted combination lines.

The photographing device combines a plurality of images (S1060). The photographing device calculates homography information using the combination lines and stitches two adjacent images using the calculated homography information.

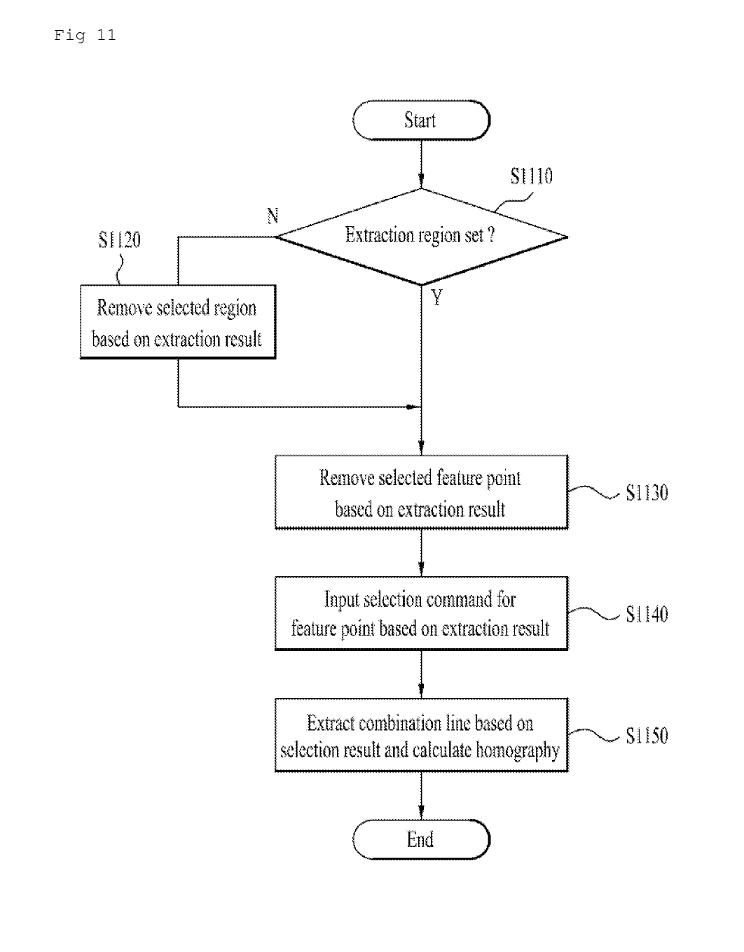

FIG. 11 is a flowchart of a stitching method of a captured image according to another embodiment of the present invention.

Referring to FIG. 11, a photographing device determines whether a feature point extraction region is set (S1110). When the feature point extraction region is not set, the photographing device removes a selected region based on an extraction result (S1120). The removal of the selected region refers to selecting a region of an entire image, from which a feature point is not extracted and then excluding the selected region. In a broad sense, the removal of the selected region may also refer to setting of the extraction region.

When the selected region is removed or the feature point extraction region is set, the photographing device extracts feature points from an object included in the extraction region. The photographing device removes the selected feature points (S1130). In addition, the photographing device may receive selection of some feature points based on the extraction result and extract combination lines based on the selected feature points (S1140).

The photographing device extracts the combination lines based on the selection result and calculates homography (S1150). The photographing device combines adjacent images using the calculated homography.

According to the aforementioned embodiments of the present invention, a stitching method of a captured image may optimally manage an algorithm operation via region setting and collection of input information to reduce a failure rate, thereby achieving an improved panoramic image.

The device and method thereof according to the present invention are not limited to the configuration and method of the aforementioned embodiments, rather, these embodiments may be entirely or partially selected in many different forms.

The method of according to the present invention can be embodied as processor readable code stored on a processor readable recording medium included in a terminal. The processor readable recording medium is any data storage device that can store programs or data which can be thereafter read by a processor. Examples of the processor readable recording medium include read-only memory (ROM), random-access memory (RAM), CD-ROMs, magnetic tapes, hard disks, floppy disks, flash memory, optical data storage devices, and so on, and also include a carrier wave such as transmission via the Internet. The processor readable recording medium can also be distributed over network coupled computer systems so that the processor readable code is stored and executed in a distributed fashion.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A stitching method of a captured image of a multi camera, the method comprising:
capturing a plurality of images having different viewing angles;
setting a extraction region on the plural images;
extracting a plurality of feature points from a plurality of objects in the set region;
extracting a combination line connecting corresponding feature points based on the plural extracted feature points;
outputting the extracted combination line; and
combining the plural images based on the extracted combination line,
wherein the setting of the extraction region comprises setting the extraction region based on a selected point when a selection command for one point is input on at least one of the plural images.

2. The method according to claim 1, wherein the setting of the extraction region comprises setting a rectangular region having a line connecting a first point and a second point as one side as the extraction region when a drag command from the first point to the second point is input on the at least one of the plural images.

3. The method according to claim 1, wherein the setting of the extraction region comprises setting the extraction region with respect to a preset region based on the selected point.

4. The method according to claim 1, wherein the setting of the extraction region comprises setting a region between a straight line formed by vertically extending the first point and a straight line formed by vertically extending the second point as the extraction region.

5. The method according to claim 1, wherein the setting of the extraction region comprises removing a selected region and setting the extraction region when a selection command for a predetermined region is input on at least one of the plural images.

6. The method according to claim 1, wherein the setting of the extraction region comprises setting the extraction region based on a selected command when a selection command for at least one object in at least one of the plural images is input.

7. The method according to claim 1, further comprising receiving selection of a feature point from which the combination line is to be extracted, among the plural feature points.

8. The method according to claim 1, further comprising receiving a combination line to be removed among the extracted combination lines,
wherein the combining of the plural images comprises combining the plural images based on a combination line except for the removed combination line among the extracted combination lines.

9. The method according to claim 1, wherein the outputting of the combination line comprises outputting the combination line with different colors according to an image combination region.

10. A photographing device comprising:
a photographing unit for capturing a plurality of images having different viewing angles;
a controller for setting a extraction region on the plural images, extracting a plurality of feature points from a plurality of objects in the set region, and extracting a combination line connecting corresponding feature points based on the plural extracted feature points; and
an output unit for outputting the extracted combination line,
wherein the controller sets the extraction region based on a selected point when a selection command for one point is input on at least one of the plural images, and combines the plural images based on the extracted combination line.
